(19) United States
(12) Patent Application Publication
(10) Pub. No.: US 2012/0131371 A1
(43) Pub. Date: May 24, 2012

(54) METHOD FOR OBTAINING POWER STATES OF A COMPUTER

(75) Inventors: YA-JUAN LIU, Shenzhen City (CN); WEI SHAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/167,711

(22) Filed: Jun. 24, 2011

(30) Foreign Application Priority Data
Nov. 19, 2010 (CN) 201010551174.9

(51) Int. Cl. G06F 1/28

(52) U.S. Cl. 713/340

(57) ABSTRACT

A method for obtaining a power state of an advanced configuration and power interface (ACPI) of a computer starting a baseboard management controller (BMC) after a power supply system of the computer is powered on. The BMC detects if a power signal from the power supply system is high level or low level. If the power signal is high level, the BMC determines that the power state of the ACPI is in a power state S0. If the power signal is low level, the BMC determines that the system power state of the ACPI is in a power state S5. A basic input output system (BIOS) detects if the system power state has changed. If the system power state has changed, the BIOS sends a current power state to the BMC. The BMC sends the power state to a system management software (SMS) of the operating system. Users can obtain the power states through an interface provided by the SMS.

### BACKGROUND

1. Technical Field

Embodiments of the present disclosure relate to power supply system management systems and methods, particularly to a method for obtaining the power states of a computer.

2. Description of Related Art

The advanced configuration and power interface (ACPI) defines six power states S0-S5. Presently, to obtain the a power state of the ACPI, an engineer may connect three general purpose input output (GPIO) signal wires of a north bridge with a baseboard management controller (BMC). In such a manner, obtaining the power states depends the north bridge, however, different north bridges may provides different GPIO signals. In additional, three GPIO signal wires are needed to detect the power states.

### BRIEF DESCRIPTION OF THE DRAWINGS

FIG. 1 is a block diagram of one embodiment of a computer comprising function modules.

FIG. 2 is a flowchart of one embodiment of a method for synchronously obtaining power states S0 and S5 of the computer in FIG. 1.

FIG. 3 is flowchart of one embodiment of a method for synchronously obtaining power states S1-S4 of the computer in FIG. 1.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

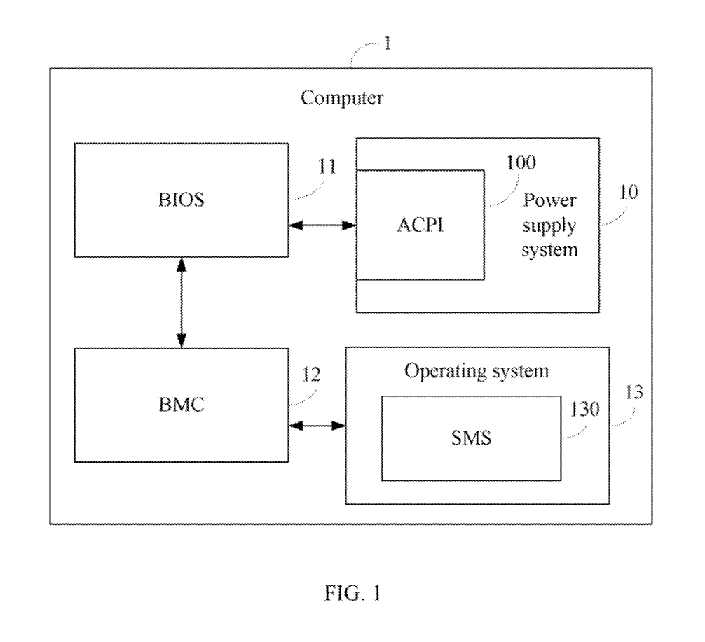

FIG. 1 is a block diagram of one embodiment of a computer 1 comprising function modules. In one embodiment, the computer 1 may be a desktop computer, a notebook, or a server. The computer 1 includes a power supply system 10. The power supply system 10 includes the advanced configuration and power interface (ACPI) 100. The power supply system 10 connects with a basic input output system (BIOS) 11 via the ACPI 100. The BIOS 11 detects the power states of the ACPI 100. The BIOS 11 connects with a baseboard management controller (BMC) 12. If the power state of the ACPI 100 changes, the BIOS 11 sends a current power state of the ACPI to the BMC 12.

The computer 1 includes an operating system 13. The operating system 13 includes system management software (SMS) 130. The SMS 130 obtains the power states from the BMC 12. The SMS 130 provides an interface (not shown) for users to obtain the power states.

The ACPI 100 defines six different power states ranging from S0 (the computer 1 is completely powered ON and fully operational) to S5 (the computer 1 is completely powered OFF) and the power states (S1, S2, S3 and S4) are referred to as sleeping states, in which the computer 1 appears OFF because of low power consumption and retains enough of a hardware context to return to a working state without a system reboot.

The BMC 12 detects the power states S0 and S5 of the ACPI 100 according to a power signal from the power supply system 10. The SMS 130 sends an obtaining command to the BMC 12. In one embodiment, the obtaining command is a command/signal that may be used to obtain the power state of the ACPI 100 from the BMC 12. The BMC 12 sends the power states S0 or S5 to the SMS 130 in reply to receiving the obtaining command. The BIOS 11 detects the power state S1, S2, S3, or S4 of the ACPI 100 and sends the detected power state to the BMC 12. The users can obtain the power state from the interface provided by the SMS 130. Therefore, the BMC 12 and the operating system 13 can synchronously obtain the power states S0 or S5 of the ACPI 100. The BIOS 11 and the BMC 12 can synchronously obtain the power states S1, S2, S3, or S4 of the ACPI 100.

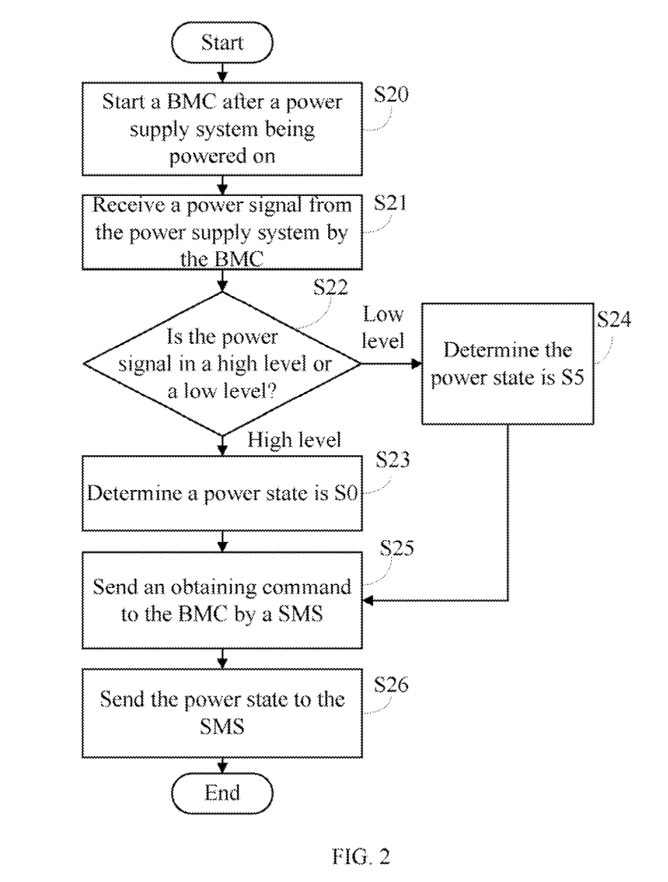

FIG. 2 is a flowchart of one embodiment of a method for obtaining power states S0 and S5 of the computer 1. Depending on the embodiment, additional blocks may be added, others removed, and the ordering of the blocks may be changed.

In block S20, the BMC 12 starts up after the power supply system 10 is powered on.

In block S21, the BMC 12 obtains a power signal from the power supply system 10. In one embodiment, the power signal may be a power good signal.

In block S22, the BMC 12 detects if the power signal is high level or low level. In one embodiment, the high level may be 5 volts and the low level may be 0 volts. If the power signal is high level, block S23 is implemented, the BMC determines that the ACPI 100 is in the power state S0. If the power signal is low level, block S24 is implemented, the BMC determines that the ACPI 100 is in the power state S5. After block S23 or block S24 has been implemented, the procedure goes to block s25.

In block S25, the SMS 130 sends the obtaining command to the BMC 12. In one embodiment, the obtaining command may be a “get ACPI power state command.”

In block S26, the BMC 12 sends the power state of the ACPI 100 to the SMS 130. The users obtains the system power state of the ACPI 100 through the interface provided by the SMS 130.

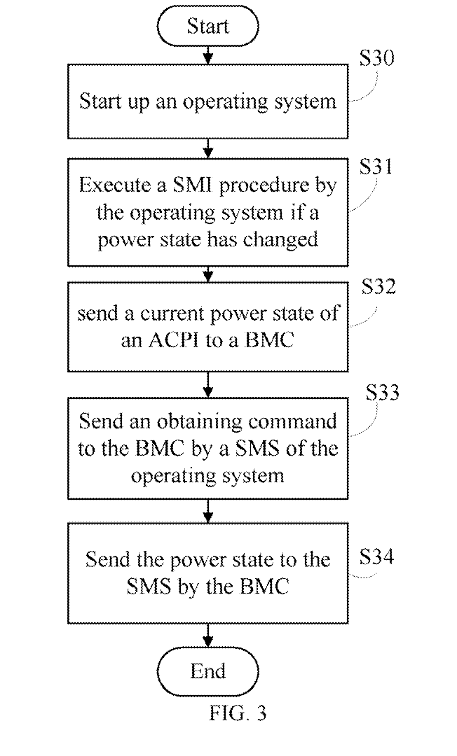

FIG. 3 is a flowchart of one embodiment of a method for obtaining power states S1-S4. Depending on the embodiment, additional blocks may be added, others removed, and the ordering of the blocks may be changed.

In block S30, the operating system 13 is started up after the power supply system being powered on.

In block S31, if the BIOS 11 detects the system power state of the ACPI has changed, the operating system 13 executes a system management interrupt (SMI) handling procedure.

In block S32, the BIOS 11 sends an informing command to the BMC 12. The informing command includes a current power state of the ACPI 100. In one embodiment, the informing command may be a “set ACPI power state” command.

The current power state may be power state S1, S2, S3, or S4.

In block S33, the SMS 130 sends the obtaining command to the BMC 12.

In block S34, the BMC 12 sends the current power state of the ACPI 100 to the SMS 130. The users obtains the current power state of the ACPI 100 through the interface provided by the SMS 130.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for obtaining power states of a computer, comprising:
starting up a baseboard management controller (BMC) of the computer after a power supply system of the computer is powered on;
receiving a power signal from the power supply system by the BMC;
determining that the power state of the advanced configuration and power interface (ACPI) is in a power state SO if the power signal is high level, or determining that the power state of the ACPI is in a power state S5 if the power signal is low level; and
sending the power state to an operating system of the computer.

2. The method as claimed in claim 1, before sending the power state to the operating system of the computer, further comprising:
sending an obtaining command to the BMC by a system management software (SMS) of the operating system.

3. The method as claimed in claim 2, further comprising:
obtaining the power state of the ACPI through an interface provided by the SMS.

4. The method as claimed in claim 1, wherein the power signal is a power good signal.

5. A method for obtaining power states of a computer, comprising:
starting up an operating system of the computer after a power supply system of the computer is powered on;
executing a system management interrupt (SMI) handling procedure by the operating system if the power state of the advanced configuration and power interface (ACPI) has changed; and
sending an informing command to a baseboard management controller (BMC), the informing command comprising obtaining a current power state of the ACPI.

6. The method as claimed in claim 5, further comprising:
sending an obtaining command to the BMC by a system management software (SMS) of the operating system;
sending the current power state of the ACPI to the SMS by the BMC; and
obtaining the power state by users through an interface provided by the SMS.

7. The method as claimed in claim 5, wherein the power state is a power state S1, S2, S3, or S4.
